(19) United States
(12) Patent Application Publication
(10) Pub. No.: US 2010/0248084 A1
(43) Pub. Date: Sep. 30, 2010

(54) FLEXIBLE CURRENT COLLECTING FIBER BUNCH AND FUEL CELL STRUCTURE USING THE SAME

(76) Inventors: Ming-San Lee, Kaohsiung City (TW); Long-Jeng Chen, Kaohsiung City (TW); Wei-Ting Shiu, Kaohsiung City (TW); Bo-Yu Liu, Kaohsiung City (TW)

Correspondence Address: Muncy, Geissler, Olds & Lowe, PLLC, 4000 Legato Road, Suite 310, FAIRFAX, VA, 22033, US

(21) Appl. No.: 12/626,235

(22) Filed: Nov. 25, 2009

(30) Foreign Application Priority Data
Mar. 30, 2009 (TW) 098110539
Apr. 3, 2009 (TW) 098111316

(51) Int. Cl. H01M 4/00; H01B 5/08

(52) U.S. Cl. 429/517; 174/128.1; 429/519

(57) ABSTRACT

A flexible current collecting fiber bunch comprises a plurality of current collecting fiber conductors and at least one electrical wire. There is an interval between each two adjacent current collecting fiber conductors. The electrical wire used to cascades the current collecting fiber conductors. The flexible current collecting fiber bunch may replace the graphite or metal bipolar commonly plate used in the fuel cell at lowers the pressure needed for a good contact and adds flexibility in the stack design.

### FIELD OF THE INVENTION

The present invention generally relates to a current collector and fuel cell structure, more particularly to a flexible current collecting fiber bunch and fuel cell structure using the same.

### BACKGROUND OF THE INVENTION

Current collecting method of fuel cell that graphite or metal bipolar commonly plate contacting with electrode is applied to collect current generated by fuel cell has been known for years. However, graphite or metal bipolar commonly plate made of rigid material is too hard to be bent unable to be applied for flexible fuel cell. Besides, it is known that a force member is required to force on the graphite or metal bipolar commonly plate to increase contact area in order to reduce contact resistance between graphite or metal bipolar commonly plate and electrode, but assemblies used by fuel cell must be robust to be capable of bearing big pressure forced by force member, which cannot reach a target of flexibility, portability and light weight.

### SUMMARY

A primary object of the present invention is to provide a flexible current collecting fiber bunch and fuel cell structure using the same. The flexible current collecting fiber bunch comprises a plurality of current collecting fiber conductors and at least one electrical wire, wherein there is an interval between two current collecting fiber conductors, the electrical wire cascades the current collecting fiber conductors. The fuel cell structure comprises a membrane electrode assembly (MEA), at least one first flexible current collecting fiber bunch, at least one at least one elastic member and at least one second flexible current collecting fiber bunch. The MEA has an anode, a cathode and an electrolyte membrane disposed between the anode and the cathode. The first flexible current collecting fiber bunch which contacts the anode of the MEA has a plurality of first current collecting fiber conductors contacting the anode and at least one first electrical wire cascading the first current collecting fiber conductors. The elastic member presses on the first flexible current collecting fiber bunch or the second flexible current collecting fiber bunch. The second flexible current collecting fiber bunch which contacts the cathode of the MEA has a plurality of second current collecting fiber conductors contacting the cathode and at least one second electrical wire cascading the second current collecting fiber conductors. The flexible current collecting fiber bunch according to the present invention may replace the graphite or metal bipolar commonly plate used in the fuel cell at lowers the pressure need for a good contact and adds flexibility in the stack design. Moreover, the present invention, applying two elastic members to press the first flexible current collecting fiber bunch and the second flexible current collecting fiber bunch respectively so as to make the first flexible current collecting fiber bunch and the second flexible current collecting fiber bunch closely contact the anode and the cathode respectively within flexural process of fuel cell structure, is capable of reducing contact resistance between the first flexible current collecting fiber bunch, the second flexible current collecting fiber bunch and the electrodes and enhancing current collecting efficiency.

### DESCRIPTION OF THE DRAWINGS

FIG. 1 is a structural view illustrating a fuel cell using flexible current collecting fiber bunch in accordance with the first preferred embodiment of the present invention.

FIG. 2 is a structural view illustrating the first flexible current collecting fiber bunch in accordance with the present invention.

FIG. 3 is a structural view illustrating the second flexible current collecting fiber bunch in accordance with the present invention.

FIG. 4 is a view illustrating flexible state within the fuel cell in accordance with an embodiment of the present invention.

FIG. 5 is a structural view illustrating another fuel cell using flexible current collecting fiber bunch in accordance with the second preferred embodiment of the present invention.

FIG. 6 is a structural view illustrating the other fuel cell using flexible current collecting fiber bunch in accordance with the third preferred embodiment of the present invention.

### DETAILED DESCRIPTION OF THE INVENTION

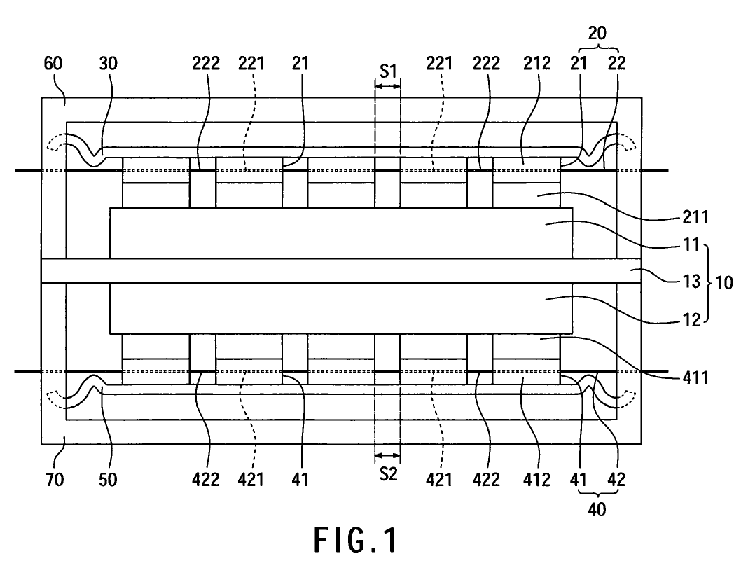

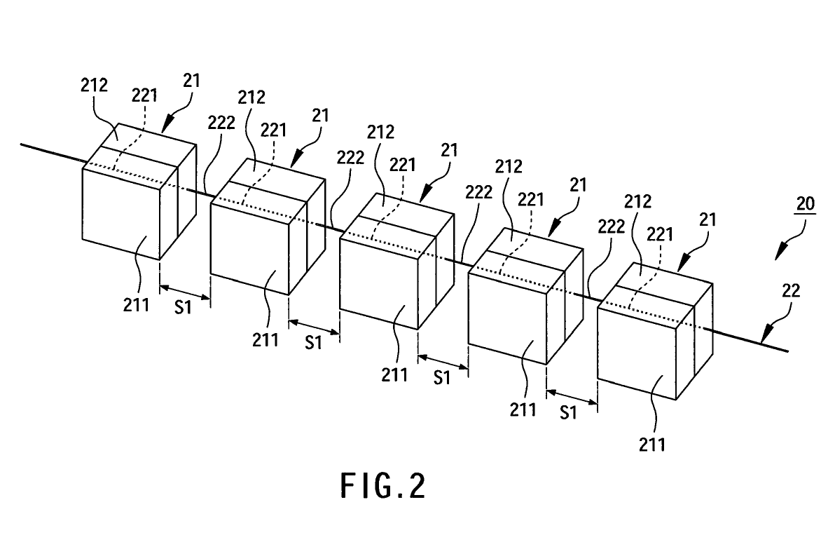

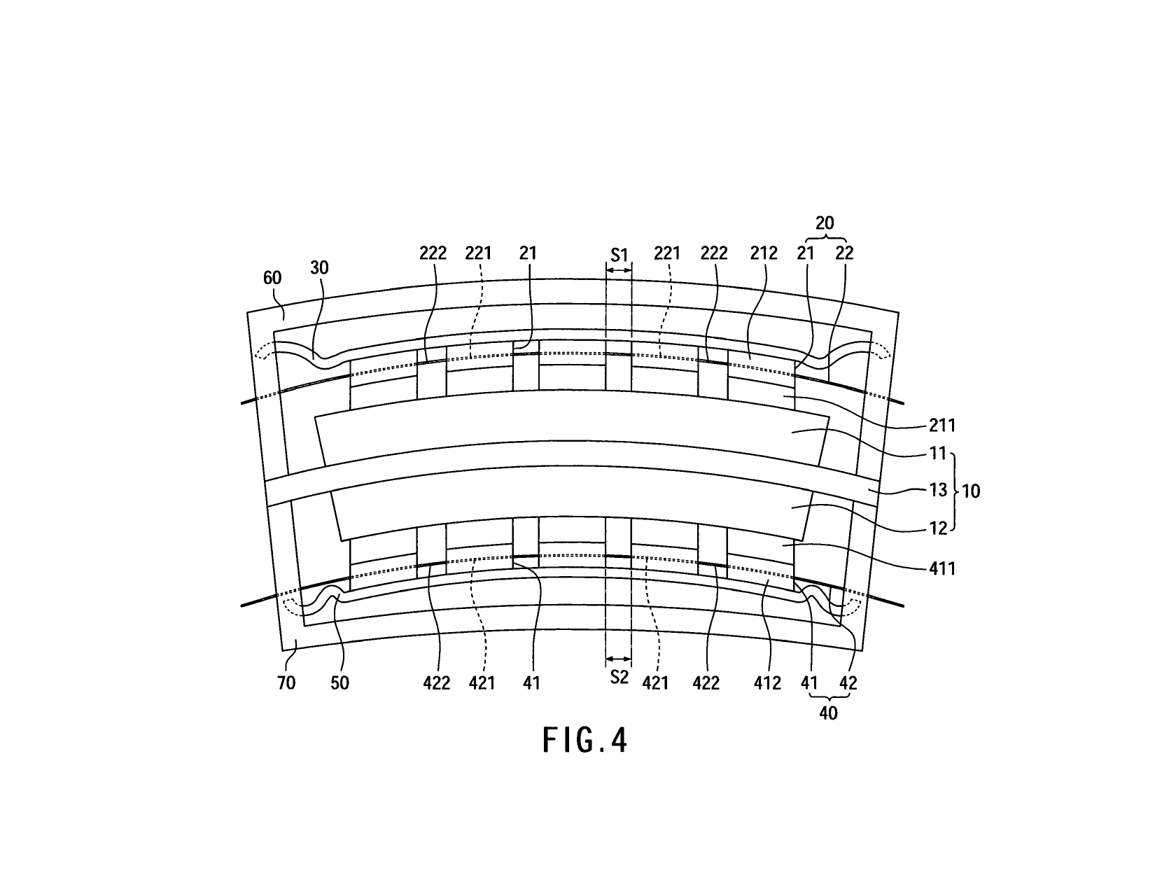

With reference to FIG. 1, a fuel cell structure using flexible current collecting fiber bunch in accordance with the first preferred embodiment of the present invention is composed of a membrane electrode assembly (MEA) 10, at least one first flexible current collecting fiber bunch 20, at least one elastic member 30, at least one second flexible current collecting fiber bunch 40, at least one elastic member 50, a first ending cover 60 and a second ending cover 70. The MEA 10 has an anode 11, a cathode 12 and an electrolyte membrane 13 disposed between the anode 11 and the cathode 12. With reference to FIGS. 1 and 2, the first flexible current collecting fiber bunch 20 which contacts the anode 11 of the MEA 10 has a plurality of first current collecting fiber conductors 21 contacting the anode 11 and at least one first electrical wire 22 cascading the first current collecting fiber conductors 21. Within this embodiment, each of the first current collecting fiber conductors 21 is formed by thermopressing carbon fibers to have a first flexible portion 211 and a first rigid portion 212 through controlling resin content within manufacturing process, otherwise within another embodiment, the first flexible portion 211 and the first rigid portion 212 may be manufactured with different materials and preferably formed by thermopressing different carbon fibers. Besides within this embodiment, there is a first interval S1 between each two adjacent first current collecting fiber conductors 21 and preferably all of the first intervals S1 are equal. The first electrical wire 22 is formed by metal having a plurality of first conductive segments 221 and a plurality of first connecting segments 222, wherein each of the first conductive segments 221 is arranged alternately with each of the first connecting segments 222 and contacts with each of the first current collecting fiber conductors 21. Within this embodiment, the first conductive segments 221 are placed between the carbon fibers prior to thermopressing process and then the first current collecting fiber conductors 21 encapsulate the first conductive segments 221 after thermoprocessing process, and preferably the first conductive segments 221 are inserted into the first rigid portions 212 of the first current collecting fiber conductors 21. Otherwise within another embodiment, the first conductive segments 221 may be adhered to contact with the first current collecting fiber conductors 21. With reference again to FIGS. 1 and 2, the first conductive segments 221 may be equal or unequal in length and preferably are equal to provide symmetrical flexibility. Each of the first connecting segments 222 is located between each two adjacent first current collecting fiber conductors 21 to connect with them and provides flexural area needed for the first flexible current collecting fiber bunch 20. The first connecting segments 222 may be equal or unequal in length within this embodiment and preferably are equal to provide uniform flexibility. In addition, the first conductive segments 221 may be equal or unequal to the first connecting segments 222 in length within this embodiment, which depends on structural requirement in application. Otherwise within the other embodiment, the first flexible current collecting fiber bunch 20 is formed by coupling each of the first current collecting fiber conductors 21 with single first electrical wire 22 and then cascading all first electrical wires 22. With reference to FIGS. 1 and 4, the elastic member 30 presses on the first current collecting fiber conductors 21 of the first flexible current collecting fiber bunch 20 to make the first current collecting fiber conductors 21 closely contact the anode 11 of the MEA 10 and prevent the first current collecting fiber conductors 21 from escaping the anode 11 within flexural process of fuel cell structure. Within this embodiment, the elastic member 30 is a spring wire with flexibility and two ends thereof are fixed at the first ending cover 60 by inserting or adhering method. With reference to FIG. 4, when the fuel cell structure is required to bend by user, the first flexible current collecting fiber bunch 20, the elastic member 30 and the first ending cover 60 can be bent and the elastic member 30 still keeps pressing on the first flexible current collecting fiber bunch 20, which makes the first current collecting fiber conductors 21 closely contact the anode 11 of the MEA 10.

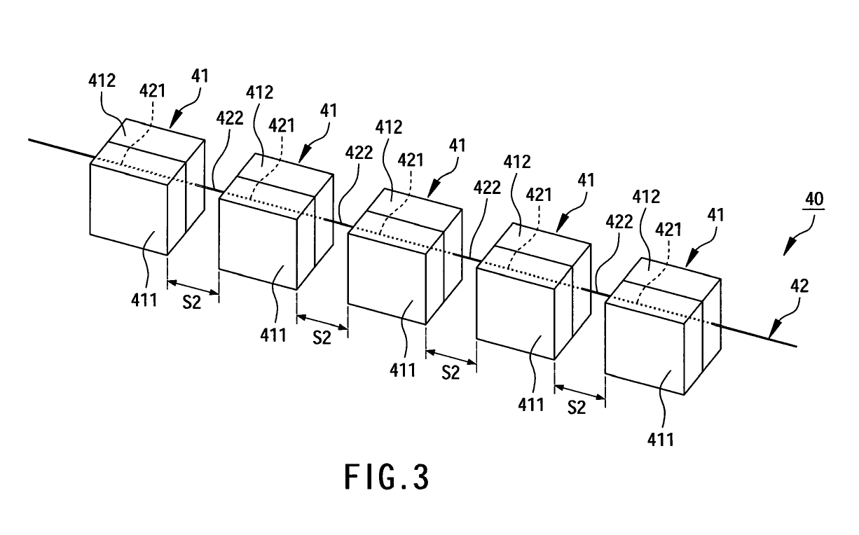

With reference to FIGS. 1 and 3, the second flexible current collecting fiber bunch 40 which contacts the cathode 12 of the MEA 10 has a plurality of second current collecting fiber conductors 41 contacting the cathode 12 and at least one second electrical wire 42 cascading the second current collecting fiber conductors 41. Within this embodiment, each of the second current collecting fiber conductors 41 is likewise formed by thermopressing carbon fibers to have a second flexible portion 411 and a second rigid portion 412 through controlling resin content within manufacturing process, otherwise within another embodiment, the second flexible portion 411 and the second rigid portion 412 may be manufactured with different material and preferably formed by thermopressing different carbon fibers. Besides within this embodiment, there is a second interval S2 between each two adjacent second current collecting fiber conductors 41 and preferably all of the second intervals S2 are equal. The second electrical wire 42 is formed by metal having a plurality of second conductive segments 421 and a plurality of second connecting segments 422, wherein each of the second conductive segments 421 is arranged alternately with each of the second connecting segments 422 and contacts with each of the second current collecting fiber conductors 41. Within this embodiment, the second conductive segments 421 are placed between the carbon fibers prior to thermopressing process and then the second current collecting fiber conductors 41 encapsulate the second conductive segments 421 after thermoprocessing process, and preferably the second conductive segments 421 are encapsulated by the second rigid portions 412 of the second current collecting fiber conductors 41. Otherwise within another embodiment, the second conductive segments 421 may be adhered to contact with the second current collecting fiber conductors 41. With reference again to FIGS. 1 and 3, the second conductive segments 421 may be equal or unequal in length and preferably are equal to provide symmetrical flexibility. Each of the second connecting segments 422 is located between each two adjacent second current collecting fiber conductors 41 to connect with them and provides flexural area needed for the second flexible current collecting fiber bunch 40. The second connecting segments 422 may be equal or unequal in length within this embodiment and preferably are equal to provide uniform flexibility. In addition, the second conductive segments 421 may be equal or unequal to the second connecting segments 422 in length within this embodiment, which depends on structural requirement in application. Otherwise within the other embodiment, the second flexible current collecting fiber bunch 40 is formed by coupling each of the second current collecting fiber conductors 41 with single second electrical wire 42 and then cascading all second electrical wires 42. With reference to FIGS. 1 and 4, the elastic member 50 presses on the second current collecting fiber conductors 41 of the second flexible current collecting fiber bunch 40 to make the second current collecting fiber conductors 41 closely contact the cathode 12 of the MEA 10 and prevent the second current collecting fiber conductors 41 from escaping the cathode 12 within flexural process of fuel cell structure. Within this embodiment, the elastic member 50 is a spring wire with flexibility and two ends thereof are fixed at the second ending cover 70 by inserting or adhering method. With reference to FIG. 4, when the fuel cell structure is required to bend by user, the second flexible current collecting fiber bunch 40, the elastic member 50 and the second ending cover 70 can be bent and the elastic member 50 still keeps pressing on the second flexible current collecting fiber bunch 40, which makes the second current collecting fiber conductors 41 closely contact the cathode 12 of the MEA 10.

With reference again to FIGS. 1 and 4, both the first and second ending covers 60, 70 have flexibility, the first ending cover 60 is disposed at one lateral of the anode 11 of the MEA 10, the elastic member 30 is located between the first ending cover 60 and the first flexible current collecting fiber bunch 20, and preferably two ends of the elastic member 30 are fixed at the first ending cover 60 respectively. Further, the second ending cover 70 is disposed at one lateral of the cathode 12 of the MEA 10, the elastic member 50 is located between the second ending cover 70 and the second flexible current collecting fiber bunch 40, and preferably two ends of the elastic member 50 are fixed at the second ending cover 70 respectively. Accordingly, the present invention applies the first flexible current collecting fiber bunch 20 and the second flexible current collecting fiber bunch 40 to replace graphite or metal bipolar commonly plate used for collecting current by known fuel cells, which may enhance flexibility of fuel cell structure in efficiency. Moreover, the present invention also, applying the two elastic members 30, 50 to press the first current collecting fiber conductors 21 of the first flexible current collecting fiber bunch 20 and the second current collecting fiber conductors 41 of the second flexible current collecting fiber bunch 40 respectively so as to make the first current collecting fiber conductors 21 and the second current collecting fiber conductors 41 closely contact the anode 11 and the cathode 12 respectively within flexural process of fuel cell structure, is capable of reducing contact resistance between the first flexible current collecting fiber bunch 20, the second flexible current collecting fiber bunch 40 and the electrodes and enhancing current collecting efficiency.

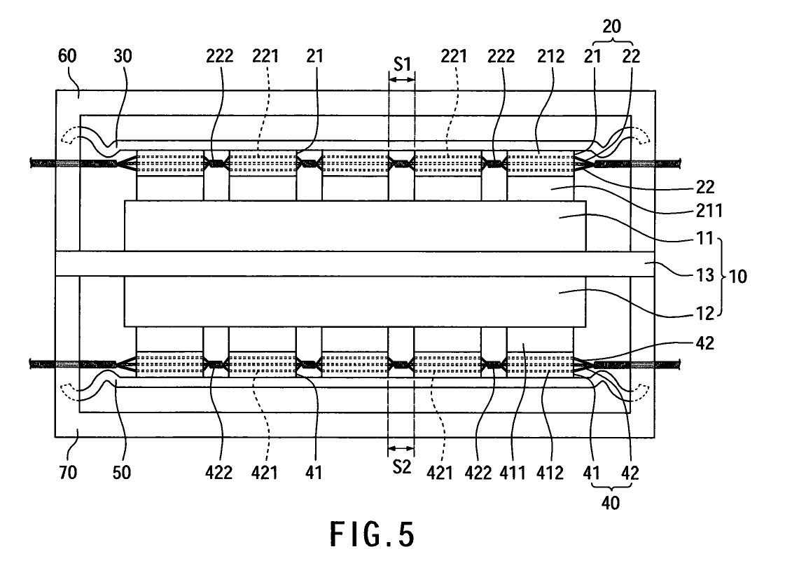

With reference to FIG. 5, a fuel cell structure using flexible current collecting fiber bunch in accordance with the second preferred embodiment of the present invention is composed of a membrane electrode assembly (MEA) 10, at least one first flexible current collecting fiber bunch 20, at least one elastic member 30, at least one second flexible current collecting fiber bunch 40, at least one elastic member 50, a first ending cover 60 and a second ending cover 70. The composition of this embodiment is basically same as that of the first preferred embodiment except that the first flexible current collecting fiber bunch 20 and the second flexible current collecting fiber bunch 40 use a plurality of first electrical wires 22 and a plurality of second electrical wires 42 respectively within this embodiment to enhance current collecting efficiency. Besides within this embodiment, the first connecting segments 222 of the first electrical wires 22 and the second connecting segments 422 of the second electrical wires 42 are bundled so as to increase tensile strength of the first flexible current collecting fiber bunch 20 and the second flexible current collecting fiber bunch 40.

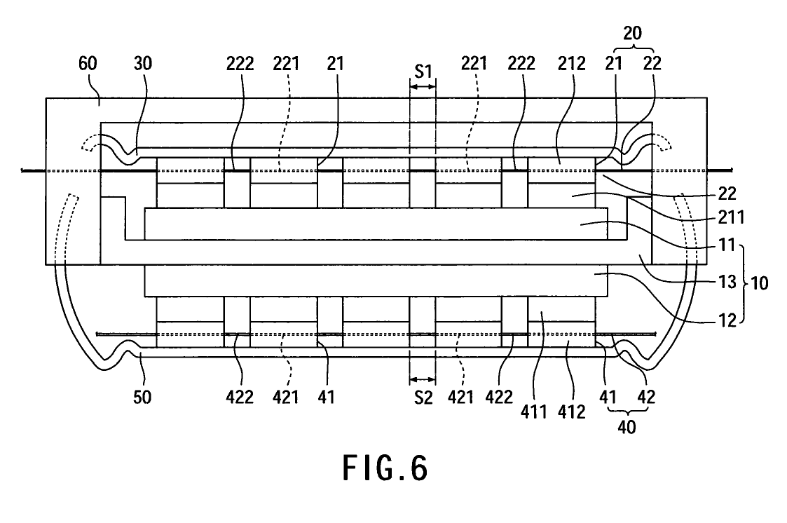

With reference to FIG. 6, a fuel cell structure using flexible current collecting fiber bunch in accordance with the third preferred embodiment of the present invention is composed of a membrane electrode assembly (MEA) 10, at least one first flexible current collecting fiber bunch 20, at least one elastic member 30, at least one second flexible current collecting fiber bunch 40, at least one elastic member 50 and a first ending cover 60. The composition of this embodiment is basically same as that of the first preferred embodiment except that the second ending cover 70 can be omitted within this embodiment.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

What is claimed is:

1. A flexible current collecting fiber bunch comprising:
a plurality of current collecting fiber conductors, there being an interval between each two current collecting fiber conductors; and
at least one electrical wire cascading the current collecting fiber conductors.

2. The flexible current collecting fiber bunch in accordance with claim 1, wherein all of the intervals are equal.

3. The flexible current collecting fiber bunch in accordance with claim 1, wherein each of the current collecting fiber conductors has a flexible portion and a rigid portion which are manufactured with different materials.

4. The flexible current collecting fiber bunch in accordance with claim 3, wherein the flexible portion and the rigid portion of each current collecting fiber conductor are fabricated by different carbon fibers.

5. The flexible current collecting fiber bunch in accordance with claim 4, wherein the electrical wire has a plurality of conductive segments and a plurality of connecting segments, each conductive segment of the electrical wire is inserted into the rigid portion of each current collecting fiber conductor.

6. The flexible current collecting fiber bunch in accordance with claim 1, wherein the electrical wire has a plurality of conductive segments and a plurality of connecting segments, each of the conductive segments contacts with each of the current collecting fiber conductors, each of the connecting segments is located between each two current collecting fiber conductors.

7. The flexible current collecting fiber bunch in accordance with claim 6, wherein all of the conductive segments of the electrical wire are equal in length and all of the connecting segments are equal in length.

8. The flexible current collecting fiber bunch in accordance with claim 6, wherein the conductive segments of the electrical wire are encapsulated by the current collecting fiber conductors separately.

9. The flexible current collecting fiber bunch in accordance with claim 1, further comprising a plurality of electrical wires having connecting segments, and the connecting segments are bundled.

10. A fuel cell structure comprising:
a membrane electrode assembly having an anode, a cathode, and an electrolyte membrane disposed between the anode and the cathode;
at least one first flexible current collecting fiber bunch having a plurality of first current collecting fiber conductors contacts the anode of the membrane electrode assembly and at least one first electrical wire cascades the first current collecting fiber conductors; and
at least one second flexible current collecting fiber bunch having a plurality of second current collecting fiber conductors contacts the cathode of the membrane electrode assembly and at least one second electrical wire cascades the second current collecting fiber conductors.

11. The fuel cell structure in accordance with claim 10, further comprising a first interval between each two adjacent first current collecting fiber conductors of the first flexible current collecting fiber bunch, the first electrical wire has a plurality of first conductive segments and a plurality of first connecting segments, each of the first conductive segments contacts with each of the first current collecting fiber conductors, each of the first connecting segments is located between each two adjacent first current collecting fiber conductors.

12. The fuel cell structure in accordance with claim 11, further comprising a second interval between each two adjacent second current collecting fiber conductors of the second flexible current collecting fiber bunch, the second electrical wire has a plurality of second conductive segments and a plurality of second connecting segments, each of the second conductive segments contacts with each of the second current collecting fiber conductors, each of the second connecting segments is located between each two adjacent second current collecting fiber conductors.

13. The fuel cell structure in accordance with claim 12, wherein each of the first current collecting fiber conductors and each of the second current collecting fiber conductors further comprising a flexible portion and a rigid portion, the flexible portion and the rigid portion are made with different materials.

14. The fuel cell structure in accordance with claim 13, wherein the flexible portions and the rigid portions of the first current collecting fiber conductors are formed by thermopressing different carbon fibers, and the flexible portions and the rigid portions of the second current collecting fiber conductors are formed by thermopressing different carbon fibers.

15. The fuel cell structure in accordance with claim 13, wherein each rigid portion of the first current collecting fiber conductors and the second current collecting fiber conductors encapsulates each conductive segment of the electrical wire.

16. The fuel cell structure in accordance with claim 12, wherein all of the first intervals between each two adjacent first current collecting fiber conductors are equal and all of the second intervals between each two adjacent second current collecting fiber conductors are equal.

17. The fuel cell structure in accordance with claim 12, wherein the first conductive segments of the first electrical wire are equal in length, the first connecting segments of the first electrical wire are equal in length, the second conductive segments of the second electrical wire are equal in length, and the second connecting segments of the second electrical wire are equal in length.

18. The fuel cell structure in accordance with claim 10, further comprising at least one elastic member to press the first flexible current collecting fiber bunch or the second flexible current collecting fiber bunch.

19. The fuel cell structure in accordance with claim 17, further comprising a first ending cover and a second ending cover, wherein the first ending cover is disposed at one lateral of the anode of the membrane electrode assembly, and the second ending cover is disposed at one lateral of the cathode of the membrane electrode assembly.

20. The fuel cell structure in accordance with claim 19, further comprising two elastic members which are disposed between the first ending cover and the first flexible current collecting fiber bunch, and between the second ending cover and the second flexible current collecting fiber bunch respectively.
